(19) United States
(12) Patent Application Publication
(10) Pub. No.: US 2010/0329415 A1
(43) Pub. Date: Dec. 30, 2010

(54) Method to inspect a blade

(76) Inventors: Henrik Stiesdal, Odense C (DK); Erik Wolf, Rottenbach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/815,443

(22) Filed: Jun. 15, 2010

(30) Foreign Application Priority Data
Jun. 30, 2009 (EP) 09008587.9

(51) Int. Cl. G01N 23/02

(52) U.S. Cl. 378/4

(57) ABSTRACT

A method of inspecting a quality of a blade, especially of a wind-turbine-blade, is provided. At least parts of the blade are inspected by a computer-tomography-method using radiation. The radiation is directed through the blade for the inspection. A transmitter sends the radiation through the blade. A receiver receives the sent radiation after its passing through the blade. The position of the transmitter, of the receiver and/or of the blade is changed in relation to each other in order to perform the inspection of the blade.

### CROSS REFERENCE TO RELATED APPLICATIONS

This application claims priority of European Patent Office Application No. 09008587.9 EP filed Jun. 30, 2009, which is incorporated by reference herein in its entirety.

### FIELD OF INVENTION

The invention relates to a method to determine the quality of a blade, especially of a wind-turbine-blade.

### BACKGROUND OF INVENTION

Blades, especially wind-turbine-blades, are built up by the help of composite materials, because this allows achieving a significant mechanical strength and a reduced weight.

Wind-turbine-blades are manufactured preferably by the use of a so called “Vacuum-Assisted-Resin-Transfer-Method, VARTM”. To assure the quality of the blade it is necessary to reduce or even avoid failures during the production-process, as these failures may result in a reduced life time of the blade or even in a final rejection of the produced blade.

The VARTM is used to create a composite structure by help of a vacuum. The vacuum is applied to components of the blade, while the components are located into a closed mould. Vacuum is applied to the closed mould, so a resin like epoxy is brought into the closed mould to penetrate the components.

The used blade-components may be pre-assembled. It is also possible to stack blade-components onto a lower mould in a sandwich-buildup to get a finished blade-structure. Next an upper mould is brought onto the blade-structure and is attached to the lower mould.

Faults during the VARTM-process itself or even faults related to the blade-components may result in local defects, leading to possible failure points of the blade.

It is possible to detect defects of the blade by a visual inspection. In this case only defects at the surface of the blade can be detected, because of the cured resin it is not possible to detect defects, which are between the blade-layers.

Additionally this detection-method is dependant to the personal, doing the visual inspection.

It is also difficulty to document the detected faults, as used photography cannot reveal fault-details compared to the human eye.

It is also possible to detect defects of the blade by an ultra-sound-inspection. This inspection is time-consuming and needs a high effort as a wind-turbine-blade show a length of up to 50 meters and beyond.

Due to the time constrains and due to economic considerations only most critical areas of the blade are inspected.

Additionally ultrasonic-inspection can not be used to determine an orientation of fibers, used inside the blade, in an accurate manner. As the fiber-orientation accounts most to the blade characteristics, this is a major drawback of this method.

Right now even X-ray based methods were performed to blades. The used systems are complicated and they are limited to sections of the blade only. Therefore these systems are not suitable.

### SUMMARY OF INVENTION

It is an object of the invention to provide an improved method for blade-inspection, which is especially applicable for a blade of a wind-turbine.

According to the invention relevant sections or parts of the blade are inspected by a method, which is based on computer-tomography (CT).

According to the invention at least parts of a blade, for example of a wind-turbine-blade, is inspected by using a computer-tomography-method. This method uses a kind of radiation, which is directed through the blade for the inspection. A transmitter sends the radiation through the blade. A receiver receives the sent radiation after its passing through the blade. The position of the transmitter, of the receiver and/or of the blade is changed in relation to each other, to perform the inspection of the blade.

The CT-technology uses a penetrating radiation like x-ray for the blade-inspection.

To generate this radiation an accelerator or a nuclide source may be used.

By help of a steering-system the radiation is directed through the blade. This might be done in form of a single beam or a number of beams, which might overlap to be shaped like a fan.

In this case the beam(s) is (are) swept through the blade while the inspection is done.

A used receiver-unit may comprise a “charge coupled device, CCD” or a similar device to generate a number of images, while each image is related to a certain cross-section of the blade.

As the radiation will be damped in dependency of the error type and its size the damping is used to generate the image. According to this the receiver receives the radiation with different intensities by help of a sensor array.

By help of a post-processing-method an evaluation of quality differences of the blade and its composite is established.

By help of an algorithm, which detects certain patterns at the images, a quality-issue of the material can be found automatically.

The inventive method allows a 100% proof of the whole blade, while the blade-inspection is done in a single testing-passage in a preferred embodiment.

For this the position of the receiver and/or of the radiation source and/or of the blade are changed in relation to each other to inspect the blade.

For example the receiver and the source may be rotated in an orbit around the blade for the inspection.

It is also possible to change the position of the receiver and/or the source in a linear way along dedicated lines to allow the inspection of the blade.

It is also possible to use an array of N radiation-sources and/or an array of M receivers. In this case it would be possible to fix their positions and to use a N×M matrix to describe mathematically their relationship while the blade inspection.

A localizer-unit is used to provide information about the inspected cross-section of the blade (for example it provides angle and transversal location and depth of the field).

An electronic processing unit translates a variation of received intensity and of a location pointer into a data set or into a signal, which will be used to visualize the image as described above.

The image allows a high-qualitative inspection of the composite material of the blade and also to determine a location of defects.

The invention allows a 100% inspection of the blade and a visualization of an inner and an outer blade-structure, even in a 3D-view.

In a preferred embodiment at least one emitting and a number of receiving devices are used for the inspection. This improves the quality and/or to reduce the needed time for the blade-inspection

In another preferred embodiment the intensity of the radiation is modulated to improve the visualization.

To improve the visualization it is also possible to align the tilt-angle of the emitting/receiving devices in reference to the blade. This allows an optimization of the penetration of the radiation, especially usable for the inspection of thick parts of the blade.

In a preferred embodiment an optional indicator-unit is coupled with the inspection-system. It is used to mark relevant fault-areas for a further post-processing of the blade.

In a preferred embodiment an optional preparation unit is used, which prepares the marked areas for subsequent steps of work—for a repair for example. For example the preparation unit removes fault blade-material.

In a preferred embodiment an optional repair unit is used to repair the fault areas. This repair-unit comprises for example tools like grinders, milling cutters or similar to be used for the preparation of the fault-area.

In a preferred embodiment the rotation movement of the emitting/receiving-devices around the blade is replaced by a linear-transversal movement of the devices in reference to the blade.

In a preferred embodiment the inspection-system is arranged as a mobile unit to allow a blade-inspection at certain different sites.

### BRIEF DESCRIPTION OF THE DRAWINGS

The invention will be shown by help of a drawing now.

FIG. 1 shows a first inspection-method of a blade according to the invention, and

FIG. 2 shows a second inspection-method of a blade according to the invention.

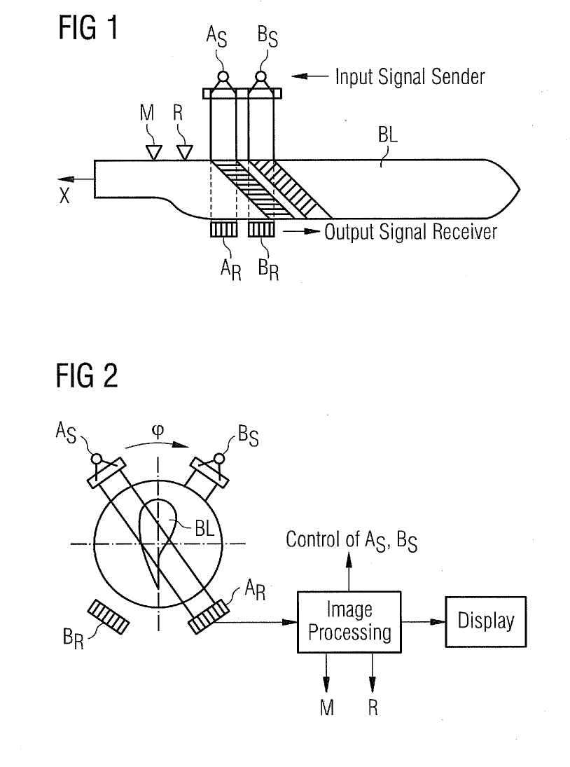

For FIG. 1 and FIG. 2 the following abbreviations are used:
BL as blade,
AS, BS as sender or transmitters,
AR, BR as receiver,
x as axial position,
φ as circumferential position,
M as marking unit and
R as repair and preparation unit.

### DETAILED DESCRIPTION OF INVENTION

FIG. 1 shows a first inspection-method of a blade according to the invention.

According to the invention relevant sections or parts of the blade BL are inspected by a computer-tomography based method.

A first sender AS and a second sender BS are sending a kind of radiation through the blade BL for the inspection.

As radiation x-ray is used for the blade-inspection. The radiation is directed by help of a steering-system.

A first receiver AR and a second receiver BR are receiving the radiation after it passed through the blade BL.

The positions of the senders AS, BS and of the receivers AR, BR are changed in relation to each other, to perform the inspection of the blade BL.

In this case the positions of the receivers AR, BR and/or of the senders AS, BS are changed in a linear way along dedicated lines to allow the inspection of the blade BL.

In this case two beams are used, which are swept through the blade BL while the inspection is done.

The output signals of the receivers AR, BR are guided to a image-processing-unit (not shown here) for further evaluation. By help of a post-processing-method an evaluation of quality differences of the blade BL and its composite is established.

By help of an algorithm, which detects certain patterns at the images, a quality-issue of the material can be found automatically.

As described above a marking unit M and a repair and preparation unit R is used to mark and repair damages.

The input-signals of the senders AS, BS are created by help of a signal-unit (not shown here). For example an accelerator or a nuclide source is used to generate the radiation.

FIG. 2 shows a second inspection-method of a blade according to the invention.

Here the positions of the receivers AR, BR and/or of the senders AS, BS are changed in relation to each other to inspect the blade BL. They are rotated by an angle φ in a circumferential manner. They are rotated in an orbit around the blade BL for the inspection.

The output-signals of the receivers AR, BR are passed to an image processing unit and to a display for further evaluations.

The image processing unit creates signals for the marking unit M and for the repair and preparation unit R.

It further creates signals to control the senders AS, BS.

1.-13. (canceled)

14. A method of inspecting a blade of a wind turbine, comprising:
inspecting parts of the blade by a computer-tomography-method using radiation;
sending the radiation through the blade by a transmitter;
receiving the sent radiation after passing through the blade by a receiver,
wherein a position of the transmitter or the receiver is changed in order to perform the inspecting of the blade.

15. The method according to claim 14, wherein a position of the blade is changed in order to perform the inspecting of the blade.

16. The method according to claim 14, wherein the radiation is directed and guided via a beam or a plurality of beams through the blade, and wherein the beam is directed through the blade at a certain cross-section of the blade.

17. The method according to claim 14, wherein the transmitter or the receiver is partially rotated in an orbit around the blade for the inspection.

18. The method according to claim 14, wherein the transmitter or the receiver is moved linear-transversal in relation to the blade for the inspection.

19. The method according to claim 14,
wherein the transmitter comprises a number of N single transmitters, and
wherein the receiver comprises a number of M single receivers, which are coupled in form of a N×M matrix.

20. The method according to claim 14,
wherein a CCD-device is used as the receiver to generate images which are related to certain cross-sections of the blade, and/or
wherein a localizer-unit is used to provide information related to the position of the inspected cross-section.

21. The method according to claim 20, wherein the images are evaluated by a post-processing-method, the post-processing-method being used to determine quality differences of the blade.

22. The method according to claim 20, wherein an algorithm is used to detect certain fault-patterns at the images.

23. The method according to claim 14, wherein an intensity of the radiation is modulated during the inspection in order to improve the results of the inspection.

24. The method according to claim 14, wherein a tilt-angle of the transmitter or of the receiver in reference to the blade is adjusted in order to improve the results of the inspection.

25. The method according to claim 14,
wherein an indicator-unit is used to mark detected fault-areas of the blade, or
wherein a preparation-unit is used to prepare the marked areas for a subsequent repair, or
wherein a repair-unit is used to repair the fault areas, the repair-unit using tools like grinders and milling cutters.

26. A method of inspecting a blade of a wind turbine, comprising:
inspecting parts of the blade by a computer-tomography-method using radiation;
sending the radiation through the blade by a transmitter;
receiving the sent radiation after passing through the blade by a receiver,
wherein a position of the blade is changed in order to perform the inspecting of the blade.

27. The method according to claim 26, wherein the radiation is directed and guided via a beam or a plurality of beams through the blade, and wherein the beam is directed through the blade at a certain cross-section of the blade.

28. The method according to claim 26, wherein the transmitter comprises a number of N single transmitters and wherein the receiver comprises a number of M single receivers, which are coupled in form of a N×M matrix.

29. The method according to claim 26,
wherein a CCD-device is used as the receiver to generate images which are related to certain cross-sections of the blade, and/or
wherein a localizer-unit is used to provide information related to the position of the inspected cross-section.

30. The method according to claim 29, wherein the images are evaluated by a post-processing-method, the post-processing-method being used to determine quality differences of the blade.

31. The method according to claim 29, wherein an algorithm is used to detect certain fault-patterns at the images.

32. The method according to claim 26, wherein an intensity of the radiation is modulated during the inspection

33. The method according to claim 26,
wherein an indicator-unit is used to mark detected fault-areas of the blade, or
wherein a preparation-unit is used to prepare the marked areas for a subsequent repair, or
wherein a repair-unit is used to repair the fault areas, the repair-unit using tools like grinders and milling cutters.
